(19) United States
(12) Patent Application Publication
(10) Pub. No.: US 2009/0191821 A1
(43) Pub. Date: Jul. 30, 2009

(54) METHOD AND SYSTEM FOR TRANSMIT PATH FILTER AND MIXER CO-DESIGN

(76) Inventors: Spyridon Charalabos Kavadias, Voula (GR); Konstantinos Dimitrios Vavelidis, Ilioupolis (GR)

Correspondence Address: MCANDREWS HELD & MALLOY, LTD, 500 WEST MADISON STREET, SUITE 3400, CHICAGO, IL, 60661, US

(21) Appl. No.: 12/019,780

(22) Filed: Jan. 25, 2008

(51) Int. Cl. H04B 1/38

(52) U.S. Cl. 455/73

(57) ABSTRACT

Aspects of a method and system for transmit path filter and mixer co-design are provided. In this regard, a filter may generate an output current based on a voltage applied to the filter and based on a feedback current produced by the filter, and a current mirror may mirror the generated output current into a mixer. Additionally, the output current may be filtered by a transconductance and a capacitance at an input of the current mirror. This filtering may reduce out-of-band noise generated by the voltage to current conversion devices. A gain of an output of the mixer may be controlled by varying a width of one or more transistors of the current mirror and/or by varying a resistance coupled to the current mirror input. A frequency response of the filter may be controlled by varying the gate width and the capacitance at the input of the current mirror.

### CROSS-REFERENCE TO RELATED APPLICATIONS/INCORPORATION BY REFERENCE

Not Applicable.

### FIELD OF THE INVENTION

Certain embodiments of the invention relate to signal processing. More specifically, certain embodiments of the invention relate to a method and system for transmit path filter and mixer co-design.

### BACKGROUND OF THE INVENTION

The number and types of wireless and wireline communication standards and corresponding communication devices continues to grow each year. Although, these devices and standards may differ greatly from one standard to the next, a large percentage of communication standards/protocols do not utilize baseband communications. Accordingly, many communication devices are required to perform frequency conversion in order to communicate with remote devices. In this regard, baseband signals are typically up-converted in an RF front end prior to transmission.

Up-conversion typically involves mixing a baseband signal with a local oscillator signal in order to generate inter-modulation products at a desired transmit frequency. In this regard, a mixer may be a critical element of an RF front end due to the fact that frequency conversion may consume significant amounts of power and/or introduce large amounts of noise. Additionally, mixer design may be complex and costly when, for example, high linearity is required in order to process wideband signals. Also, an RF front end typically needs to perform some filtering/conditioning of baseband signals prior to up-conversion. In this regard, filtering may remove extraneous signals and noise in order to improve transmitter performance.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for transmit path filter and mixer co-design, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary RF communication device, in accordance with an embodiment of the invention.

FIG. 2 is block diagram illustrating a co-designed filter and mixer, in accordance with an embodiment of the invention.

FIG. 3A is a diagram of an exemplary first portion of a co-designed filter and mixer, in accordance with an embodiment of the invention.

FIG. 3B is a diagram of an exemplary second portion of a co-designed filter and mixer, in accordance with an embodiment of the invention.

FIG. 4 is a flowchart illustrating exemplary steps for signal transmission utilizing a co-designed filter and mixer, in accordance with an embodiment of the invention.

### DETAILED DESCRIPTION OF THE INVENTION

Certain embodiments of the invention may be found in a method and system for transmit path filter and mixer co-design. In this regard, a filter may generate an output current based on a voltage applied to the filter and based on a feedback current produced by the filter, and a current mirror may mirror the generated output current into a mixer. Additionally, the output current may be filtered by a transconductance and a capacitance at an input of the current mirror. A gain of an output of the mixer may be controlled by varying a width of one or more transistors of the current mirror and/or by varying a resistance coupled to the current mirror input. A frequency response of the filter may be controlled by varying the gate width and the capacitance at the input of the current mirror, and/or the resistances and/or capacitors of the filter. A baseband signal input to the filter may be filtered to generate the output current and the output current may be up-converted to RF by the mixer. In various embodiments of the invention, a filter circuit may generate a feedback current via a transconductance, and the transconductance may convert a voltage output of said filter to a current input of a mixer.

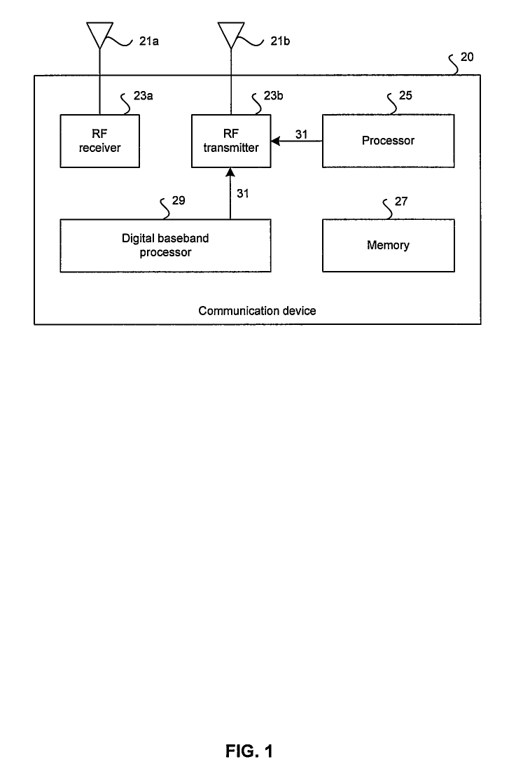

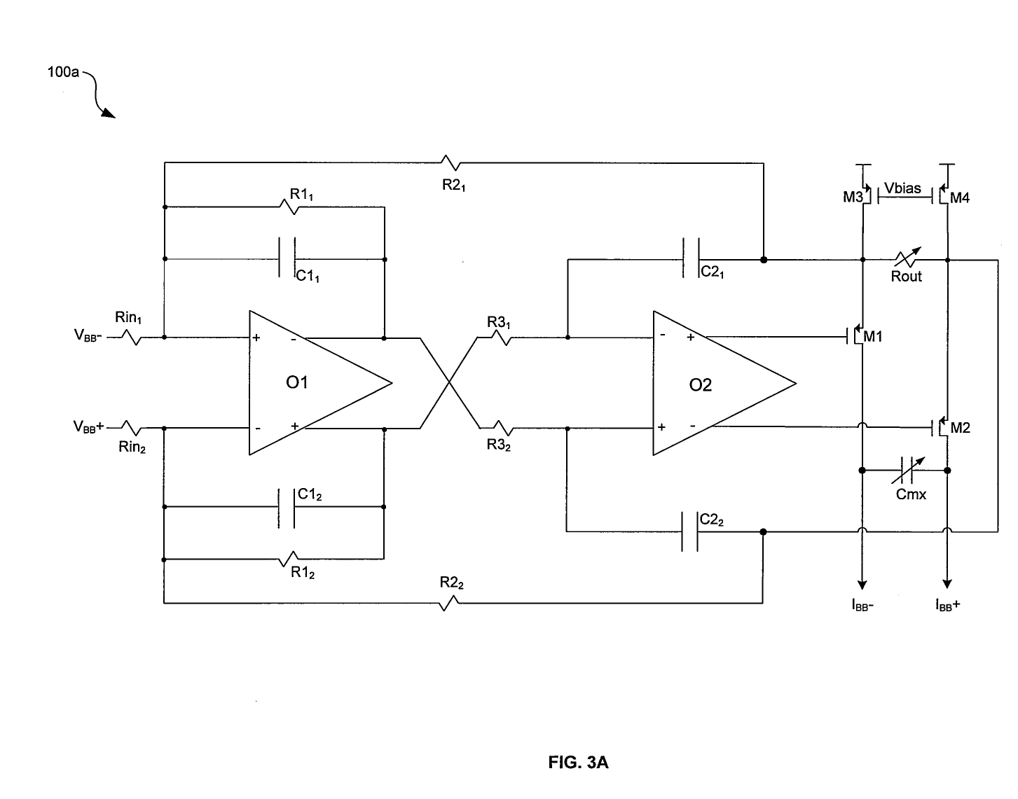

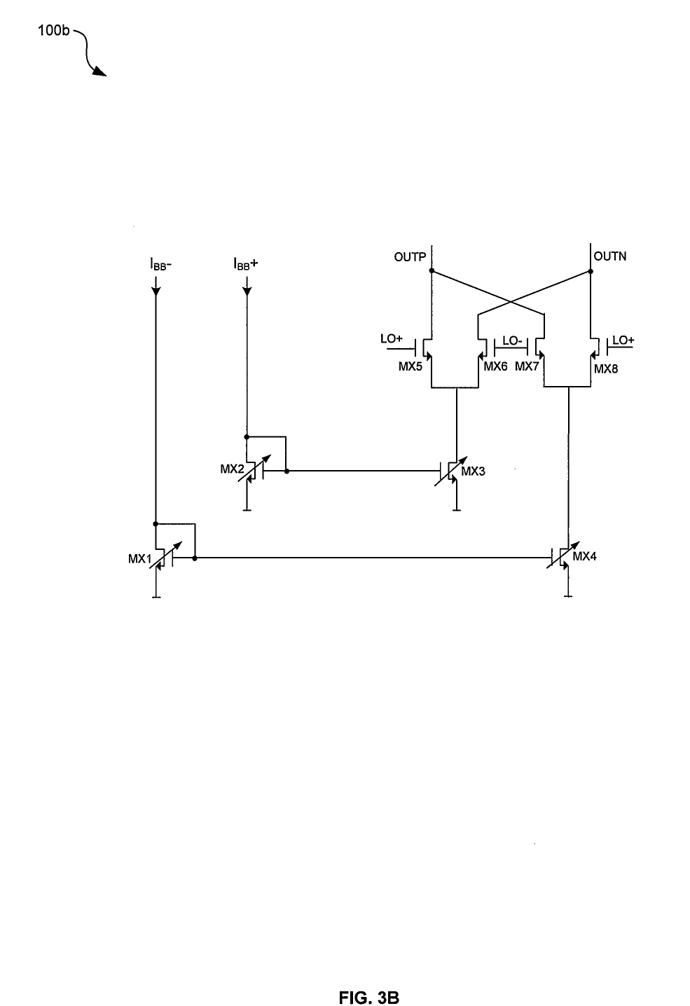

FIG. 1 is a block diagram illustrating an exemplary RF communication device, in accordance with an embodiment of the invention. Referring to FIG. 3, there is shown a RF communication device 20 that may comprise an RF receiver 23a, an RF transmitter 23b, a digital baseband processor 29, a processor 25, and a memory 27. A receive antenna 21a may be communicatively coupled to the RF receiver 23a. A transmit antenna 21b may be communicatively coupled to the RF transmitter 23b. The RF communication device 20 may be operated in a system, such as the cellular network and/or digital video broadcast network, for example.

The RF receiver 23a may comprise suitable logic, circuitry, and/or code that may enable processing of received RF signals. In this regard, the receiver may be enabled to generate signals, such as local oscillator signals, for the reception and processing of RF signals. The RF receiver 23a may down-convert received RF signals to a baseband frequency signal. The RF receiver 23a may perform direct down-conversion of the received RF signal to a baseband frequency signal, for example. In some instances, the RF receiver 23a may enable analog-to-digital conversion of the baseband signal components before transferring the components to the digital baseband processor 29. In other instances, the RF receiver 23a may transfer the baseband signal components in analog form.

The digital baseband processor 29 may comprise suitable logic, circuitry, and/or code that may enable processing and/or handling of baseband frequency signals. In this regard, the digital baseband processor 29 may process or handle signals received from the RF receiver 23a and/or signals to be transferred to the RF transmitter 23b. The digital baseband processor 29 may also provide control and/or feedback information to the RF receiver 23a and to the RF transmitter 23b based on information from the processed signals. In this regard, the baseband processor 29 may provide one or more control signals to a co-designed filter and mixer in the RF transmitter 23b to configure a gain and/or frequency response of the filter/mixer. The digital baseband processor 29 may communicate information and/or data from the processed signals to the processor 25 and/or to the memory 27. Moreover, the digital baseband processor 29 may receive information from the processor 25 and/or to the memory 27, which may be processed and transferred to the RF transmitter 23b for transmission to the network.

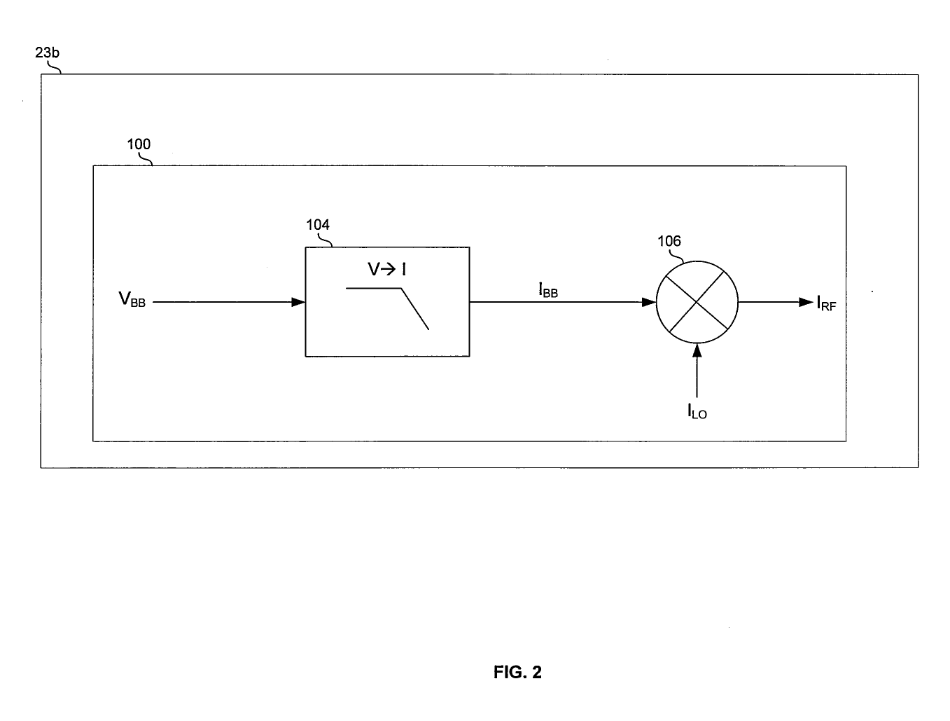

The RF transmitter 23b may comprise suitable logic, circuitry, and/or code that may enable processing of RF signals for transmission. In this regard, the transmitter may be enabled to generate signals, such as local oscillator signals, for the transmission and processing of RF signals. The RF transmitter 23b may up-convert the baseband frequency signal to an RF signal. Accordingly, the RF transmitter 23b may comprise a co-designed filter and mixer system, such as the system 100 of FIGS. 2, 3A, 3B. In this regard, the system 100 may be configured for a desired transmit frequency and/or signal strength. For example, the system 100 may be configured via one or more control signals 31 from the baseband processor 29 and/or the processor 25. In some instances, the RF transmitter 23b may enable digital-to-analog conversion of the baseband signal components received from the digital baseband processor 29 before up conversion. In other instances, the RF transmitter 23b may receive baseband signal components in analog form.

The processor 25 may comprise suitable logic, circuitry, and/or code that may enable control and/or data processing operations for the RF communication device 20. The processor 25 may be utilized to control at least a portion of the RF receiver 23a, the RF transmitter 23b, the digital baseband processor 29, and/or the memory 27. In this regard, the processor 25 may generate at least one signal for controlling operations within the RF communication device 20. The processor 25 may also enable executing of applications that may be utilized by the RF communication device 20. For example, the processor 25 may execute applications that may enable displaying and/or interacting with content received via RF signals in the RF communication device 20.

The memory 27 may comprise suitable logic, circuitry, and/or code that may enable storage of data and/or other information utilized by the RF communication device 20. For example, the memory 27 may be utilized for storing processed data generated by the digital baseband processor 29 and/or the processor 25. The memory 27 may also be utilized to store information, such as configuration information, that may be utilized to control the operation of at least one block in the RF communication device 20. For example, the memory 27 may comprise information necessary to configure a co-designed filter and mixer system (e.g., the system 100) within the RF transmitter 23b to enable up-converting baseband signals to an appropriate frequency band for transmission.

FIG. 2 is block diagram illustrating a co-designed filter and mixer, in accordance with an embodiment of the invention. Referring to FIG. 2 there is shown a co-designed filter and mixer 100 of an RF transmitter 23b. The co-designed filter and mixer 100 of the RF transmitter may comprise a filter 104 and a mixer 106. In various embodiments of the invention, the co-designed filter and mixer 100 may be integrated in a single-chip solution and

The filter 104 may comprise suitable logic, circuitry, and/or code that may enable filtering a baseband signal to pass desired frequencies and block undesired frequencies such that, at the filter output, desired frequencies may be stronger than undesired frequencies. In this regard, one or more components of the filter 104 may be configurable such that a frequency response and/or a gain of the filter 104 may be controlled. Additionally, the filter 104 may perform voltage to current conversion such that a signal input to the filter 104 may be a voltage and a signal output of the filter 104 may be a current. Voltage to current conversion may occur in a feedback loop of the filter 104, which may improve the linearity of the filter 104.

The mixer 106 may comprise suitable logic, circuitry, and/or code that may enable generation of inter-modulation products of a local oscillator (LO) signal and a baseband signal. The mixer 106 may be a current input mixer and generate an output current by mixing a LO current and a baseband signal current. In this regard, a current input mixer may provide improved linearity over a voltage input mixer.

In operation, a baseband voltage signal V_{BB} may be applied to the filter 104. The filter 104 may be enabled to filter the signal and output a corresponding filtered baseband current signal I_{BB}. The frequency response of the filter 104 may be configurable and may be determined based on, for example, a communication standard and/or frequency band. In this regard, the mixer 106 may be coupled to the current output of the filter 104 and the loading of the mixer 106 on the filter 104 may thus impact the frequency response of the overall circuit. Accordingly, various aspects of the invention may enable compensation or accounting for the mixer input in determining the frequency characteristics of the signal I_{BB}. For example, one or more capacitances may be coupled to the common node coupling the filter 104 and the mixer 106, such that an additional pole is added to the overall frequency response of the filter/mixer co-design. In this manner, rather than designing filter 104 and mixer 106 separately and then simply combining them, aspects of the invention may utilize the interrelationship between the filter 104 and the mixer 106 to design the filter 104 and mixer 106 in parallel. The interrelated filter 104 and mixer 106 may achieve greater overall performance in terms of, for example, filter response, linearity, and noise.

FIG. 3A is a schematic diagram of an exemplary first portion of a co-designed filter and mixer, in accordance with an embodiment of the invention. In this regard, the system 100a of FIG. 3A may be a first portion of the co-designed filter and mixer 100 described with respect to FIG. 2. Referring to FIG. 3A there is shown differential amplifiers O1 and O2, transistors M1, M2, M3, and M4, and a plurality of passive elements. The plurality of passive elements may comprise resistor Rout, and resistor pairs Rin and R1, and R2 and R3. The passive elements may also comprise capacitor Cmx, and capacitor pairs C1 and C2.

The portion 100a of the co-designed filter and mixer is communicatively coupled to form a filtering circuit with voltage to current conversion in a feedback path.

A negative input of the co-designed filter and mixer may be coupled to a first terminal of resistor Rin₁ and a positive input of the co-designed filter and mixer may be communicatively coupled to a first terminal of resistor Rin₂. A second terminal of Rin₁ may be communicatively coupled to a first terminal of resistor R2₁, R1₁, C1₁, and a positive input of amplifier O1. A second terminal of Rin₂ may be communicatively coupled to a first terminal of resistor R2₂, R1₂, C1₂, and a negative input of amplifier O1. A negative output of O1 may be communicatively coupled to a second terminal of R1₁ and C1₁, and to a first terminal of R3₂. A positive output of O1 may be communicatively coupled to a second terminal of R1₂ and C1₂ and to a first terminal of R3₁. A second terminal of R3₁ may be communicatively coupled to a first terminal of C2₁ and to a negative input of amplifier O2. A second terminal of R3₂ may be communicatively coupled to a first terminal of C2₂ and to a positive input of amplifier O2. A second terminal of C2₁ may be communicatively coupled to a second terminal of R2₁, the drain of transistor M3, the source of transistor M1, and a first terminal of Rout. A second terminal of C2₂ may be communicatively coupled to a second terminal of R2₂, the drain of transistor M4, the source of transistor M2, and a second terminal of Rout. A positive output of O2 may be communicatively coupled to a gate of M1. A negative output of O2 may be communicatively coupled to the gate of M2. The drain of M1 may be communicatively coupled to a first terminal of Cmx and may be a negative current output of the portion 100a. The drain of M2 may be communicatively coupled to a second terminal of Cmx and may be a positive current output of the portion 100a.

The differential amplifiers O1 and O2 may comprise suitable logic, circuitry, and/or code that may enable buffering and/or amplification of differential signals. In this regard, an output of the amplifiers O1 and O2 may depend on a voltage applied to the input terminal of the amplifiers O1 and O2. Although a fully differential implementation is depicted, a single ended topology with single ended amplifiers may be implemented without deviating from the scope of the invention.

The various passive elements comprising resistors Rin, R1, R2 and R3, and capacitors Cmx, C1 and C2 may enable controlling, at least in part, a gain and/or a frequency response of the system 100 illustrated in FIG. 2. In various embodiments of the invention, one or more of the passive elements Rin, R1, R2 R3, Cmx, C1 and C2 may be variable. In an exemplary embodiment of the invention, the resistor Rout may be variable and may enable programmatically controlling a gain of the system 100.

In an exemplary embodiment of the invention, the transistors M1-M4 may be active devices such as PMOS transistors. The transistors M1 and M2 may provide feedback signals to the resistors R2 and also may function to convert a voltage output of the amplifier O2 to current output I_{BB}. In this regard, voltage to current conversion may be embedded in a feedback loop which may result in improved linearity over conventional methods.

Although the schematic depicted in FIG. 3A is based on a Tow-Thomas biquad filter, the invention is not limited to this implementation. In this regard, aspects of the invention comprising embedding voltage to current conversion into a filter feedback loop and co-designing a mixer input to supplement the filter response may be utilized with wide variety of filter topologies.

FIG. 3B is a schematic diagram of an exemplary second portion of a co-designed filter and mixer, in accordance with an embodiment of the invention. In this regard, the system 100b of FIG. 3B may be a second portion of the co-designed filter and mixer 100 described with respect to FIG. 2. Referring to FIG. 3B there is shown transistors MX1-MX4 and transistors MX5-MX8.

The transistors MX5-MX8 are coupled so as to form a mixing circuit. The transistors MX1-MX4 are configured as a current mirror, which mirrors the output current I_{BB} into the mixing circuit comprising transistors MX5-MX8.

A differential current input from the portion 100a of FIG. 2A may be communicatively coupled to the drain and gate of MX1 and MX2 and to the gate of MX3 and MX4. The source of MX1, MX2, MX3, and MX4 may be communicatively coupled to a DC bias voltage. The drain of MX3 may be communicatively coupled to the source of MX5 and MX6. The drain of MX4 may be communicatively coupled to the source of MX7 and MX8. The gate of MX5 and the gate of MX8 may be communicatively coupled to a positive terminal of a local oscillator. The gate of MX6 and the gate of MX7 may be communicatively coupled to a negative terminal of a local oscillator. The drain of MX5 and the drain of MX7 may be communicatively coupled to a positive output of the co-designed filter and mixer 100. The drain of MX6 and the drain of MX8 may be communicatively coupled to a negative output of the co-designed filter and mixer 100.

In an exemplary embodiment of the invention, the effective width of transistors MX1-MX4 may be variable. For example, the width may be controlled via one or more digital signals. Accordingly, the current mirror ratios MX1/MX4 and MX1/MX2 may be varied to control the signal current mirrored into the mixing circuit (transistors MX5-MX8). In this regard, the transistors MX1-MX4 may, for example, each comprise a number of unit sized transistors coupled in parallel via one or more switching elements. Thus, by programmatically controlling the switching elements, the number of unit sized transistors coupled in parallel may be adjusted to control the effective width of the transistors MX1 and MX2, for example. In this manner, gain of the system 100 may be adjusted without altering the DC current in the mixing circuit. This may be advantageous in that altering the DC current in the mixing circuit may introduce undesirable effects.

Although, altering the current mirror transistors MX1 and MX2 may provide desirable gain control characteristics, it may also alter the frequency response of the system 100. In this regard, although the capacitor Cmx may be introduce a desirable pole frequency (e.g., to filter out of band noise) that pole frequency may depend on the transconductance seen at the node to which Cmx is coupled. For example, the pole frequency may be given by the following equation:

$${f}_{p} = \frac{{g}_{m}}{2 π ( Cmx + Cp )} \qquad EQ . 1$$

where fₚ is the pole frequency, gₘ is the equivalent transconductance of the input device of the current mirror, and Cₚ is any stray capacitance at the input to the current mirror. In this regard, gₘ may depend on MX1, MX2, M1, and/or M2. Accordingly, in instances where MX1 and MX2 may be adjusted to vary a gain of the system 100, then the value of Cmx may be adjusted by a corresponding amount such that the pole frequency, fₚ, remains within determined limits. In this regard, the pole at fₚ may be determined and/or controlled to filter noise generated by transistors M1, M2, MX1, MX2, MX3, and/or MX4. Thus, the extra pole, fₚ, introduced in the co-designed filter and mixer 100 may enable a reduction in out-of-band noise in the output of the mixer.

In an exemplary embodiment of the invention, a combination of a variable resistance Rout, a variable capacitance Cmx, and variable width transistors MX1 and MX2 may provide a highly flexible and accurate means to control gain in the system 100.

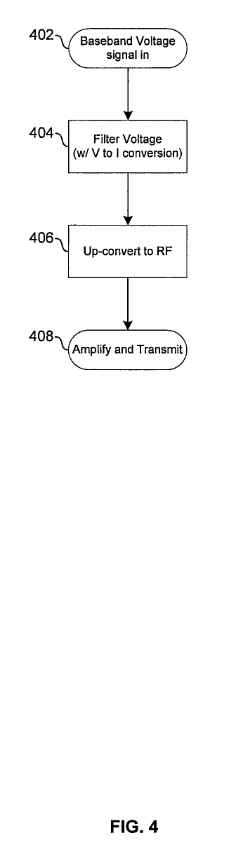

FIG. 4 is a flowchart illustrating exemplary steps for signal transmission utilizing a co-designed filter and mixer, in accordance with an embodiment of the invention. Referring to FIG. 4 the exemplary steps may begin with step 402 when a baseband voltage signal arrives at a transmitter such as the transmitter 23b of FIG. 1. Subsequent to step 4O2, the exemplary steps may advance to step 404. In step 404, the baseband voltage signal may be filtered. In this regard, voltage to current conversion may be performed in a feedback path of the filter. In this regard, the filter be similar to or the same as the portion 100a in FIG. 2A. Subsequent to step 404, the exemplary steps may advance to step 406. In step 406, the filtered signal may be mixed with a local oscillator signal and up-converted to RF. In this regard, the mixer may be similar to or the same as the portion 100b in FIG. 2B. Subsequent to step 406, the exemplary steps may advance to step 408. In step 408, the up-converted signal may be amplified and transmitted.

Aspects of a method and system for transmit path filter and mixer co-design are provided. In this regard, a filter, such as a portion of the co-designed filter and mixer 100, may generate an output current, I_{BB} of FIG. 3A, based on a voltage, V_{BB} of FIG. 3A, applied to the filter and based on a feedback current produced by the filter, such as a current through R2₁, and R2₂ of FIG. 3A, and a current mirror, such as the current mirror comprising MX1-MX4 of FIG. 3B, may mirror the generated output current into a mixer, such as the mixer comprising MX5-MX8 of FIG. 3B. Additionally, the output current may be filtered by a transconductance and a capacitance at an input of the current mirror. In this regard, the co-designed filter and mixer 100 may introduce a pole at fₚ, as described with respect to FIG. 3, and noise generated by the transistors M1,M2,M3,M4, MX1 and MX2 may be filtered by the pole at frequency fₚ. A gain of an output of the mixer may be controlled by varying a width of one or more transistors (MX1-MX4) of the current mirror and/or by varying a resistance (Rout of FIG. 3A) coupled to the current mirror input. A frequency response of the filter may be controlled by varying the gate width and the capacitance at the input of the current mirror. A baseband signal input to the filter may be filtered to generate the output current and the output current may be up-converted to RF by the mixer. In various embodiments of the invention, a filter circuit may generate a feedback current via a transconductance and the transconductance may convert a voltage output of said filter to a current input of a mixer.

Another embodiment of the invention may provide a machine-readable storage, having stored thereon, a computer program having at least one code section executable by a machine, thereby causing the machine to perform the steps as described herein for transmit path filter and mixer co-design.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
in a filter, generating an output current based on a voltage applied to said filter and based on a feedback current produced by said filter; and
mirroring said generated output current into a mixer via a current mirror, wherein said output current is filtered via a transconductance and a capacitance at an input of said current mirror.

2. The method according to claim 1, comprising filtering, via said transconductance and said capacitance, noise in said output current.

3. The method according to claim 1, comprising varying a gate width of one or more transistors of said current mirror, wherein said variation of said gate width controls a gain of an output of said mixer.

4. The method according to claim 1, comprising varying said capacitance and a gate width of one or more transistors comprising said current mirror.

5. The method according to claim 4, wherein said variation of said capacitance and said gate width controls a pole frequency for filtering noise in said output current.

6. The method according to claim 1, comprising varying a resistance coupled to said input of said current mirror, wherein said variation of said resistance controls a gain of an output of said mixer.

7. The method according to claim 1, comprising filtering a baseband signal input to said filter to generate said output current.

8. The method according to claim 7, comprising up-converting said generated output current to RF via said mixer.

9. A method for signal processing, the method comprising:
converting, via a transconductance, a voltage output of a filter circuit to a feedback current of said filter circuit; and
converting, via said transconductance, said voltage output of said filter circuit to a current input of a mixer.

10. The method according to claim 9, comprising filtering, via a pole introduced by a capacitance and a transconductance at an interface between said filter circuit and said mixer, noise generated during said conversions.

11. The method according to claim 9, comprising controlling a gain of an output of said mixer by varying a gate width of one or more transistors comprising a current mirror that mirrors current into said mixer.

12. The method according to claim 9, comprising controlling a frequency response of said filter circuit by varying a capacitance at an input of a current mirror that mirrors current into said mixer.

13. The method according to claim 9, comprising controlling a gain of an output of said mixer by varying a resistance coupled to an input of a current mirror that mirrors current into said mixer.

14. The method according to claim 9, comprising filtering a baseband signal input to said filter.

15. The method according to claim 14, comprising up-converting said filtered baseband signal to RF via said mixer.

16. A system for signal processing, the system comprising:
one or more circuits comprising a filter, a current mirror, and a mixer, wherein said one or more circuits:
generate an output current based on a voltage applied to said filter and based on a feedback current produced by said filter; and
mirror said generated output current into said mixer via said current mirror, wherein said output current is filtered via a transconductance and capacitance at an input of said current mirror.

17. The system according to claim 16, wherein said transconductance and said capacitance enable filtering noise in said output current.

18. The system according to claim 16, wherein said one or more circuits enable varying of a gate width of one or more transistors of said current mirror and said variation of said gate width controls a gain of an output of said mixer.

19. The system according to claim 16, wherein said one or more circuits enable varying of said capacitance and a gate width of one or more transistors comprising said current mirror.

20. The system according to claim 19, wherein said variation of said capacitance and said gate width controls a pole frequency for filtering noise in said output current.

21. The system according to claim 16, wherein said one or more circuits enable varying of a resistance coupled to said input of said current mirror and said variation of said resistance controls a gain of an output of said mixer.

22. The system according to claim 16, wherein said one or more circuits enable filtering of a baseband signal input to said filter to generate said output current.

23. The system according to claim 22, wherein said one or more circuits enable up-conversion of said generated output current to RF via said mixer.

24. A system for signal processing, the system comprising:
one or more circuits comprising a filter and a mixer, said one or more circuits:
convert, via a transconductance, a voltage output of said filter to a feedback current of said filter; and
convert, via said transconductance, a voltage output of said filter circuit to a current input of said mixer.

25. The system according to claim 24, wherein said one or more circuits enable filtering, via a pole introduced by a capacitance and a transconductance at an interface between said filter circuit and said mixer, noise generated during said conversions.

26. The system according to claim 24, wherein said one or more circuits control a gain of an output of said mixer by varying a gate width of one or more transistors comprising a current mirror that mirrors current into said mixer.

27. The system according to claim 24, wherein said one or more circuits control a frequency response of said filter by varying a capacitance at an input of a current mirror that mirrors current into said mixer.

28. The system according to claim 24, wherein said one or more circuits control a gain of an output of said mixer by varying a resistance coupled to an input of a current mirror that mirrors current into said mixer.

29. The system according to claim 24, wherein said one or more circuits enable filtering of a baseband signal input to said filter.

30. The system according to claim 29, wherein said one or more circuits enable up-conversion of said filtered baseband signal to RF via said mixer.
